(19) United States
(12) Patent Application Publication
(10) Pub. No.: US 2008/0150880 A1
(43) Pub. Date: Jun. 26, 2008

(54) IMAGE DISPLAYING DEVICE AND IMAGE DISPLAYING METHOD

(76) Inventors: Tatsuki Inuzuka, Mito (JP); Hiroki Kaneko, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/874,947

(22) Filed: Oct. 19, 2007

(30) Foreign Application Priority Data
Oct. 20, 2006 (JP) 2006-285662

(51) Int. Cl. G09G 3/36

(52) U.S. Cl. 345/102

(57) ABSTRACT

Crosstalk occurring in association with reduction of power consumed by the backlight module is stabilized. An input signal is processed by a signal processing circuit to be divided into an RGB backlight quantity and subpixel transmittance. Based on the quantity, a correction coefficient calculation circuit calculates a correction coefficient. A subpixel transmittance correcting circuit receives the coefficient to correct the subpixel transmittance to output corrected subpixel transmittance. The transmittance is inputted to an LCD driver circuit to drive an LCD panel. The RGB backlight quantity is inputted to an LED driver circuit to drive an LED backlight.

### BACKGROUND OF THE INVENTION

The present invention relates to an image displaying device and an image displaying method for displaying a color image on a liquid crystal display.

A liquid crystal display is a color-image display for displaying a color image by combining a backlight module with a liquid crystal panel controlling transmittance for each pixel. To display a color image on the display, the backlight thereof includes at least three color components of red (R), green (G), and blue (B). Each pixel of its liquid crystal panel includes subpixels including three color filters for red, green, and blue. The quantity of backlight is adjusted by controlling the transmittance of each subpixel to resultantly display a color image.

In the configuration, a subpixel indicates a pixel of the minimum unit including either one of the red, green, and blue color filters. Three red, green, and blue (RGB) subpixels are combined with each other to construct one pixel. The screen includes a plurality of pixels arranged on one plane of the screen.

The display principle will be simply summarized as follows. By adjusting the quantity of light from the backlight according to the liquid crystal transmittance for each subpixel, it is possible to control gradation for each subpixel. By adding a color filter to each subpixel as above, gradation can be obtained for red, green, and blue in the displayed image. Display power in this situation results on the basis of multiplication between the quantity of backlight and the liquid crystal transmittance. Although there actually exists a situation wherein the signal characteristic includes a nonlinear characteristic called gamma characteristic, it is assumed in the description that the signal characteristic is a linear characteristic.

In a configuration in which a fluorescent lamp is continuously on as the backlight, the quantity of backlight is fixed, and hence the variable in the multiplication is the liquid crystal transmittance of the subpixel. On the other hand, in a configuration in which the quantity of backlight is modulated according to a display image to be displayed on the screen, the multiplication includes two variables, i.e., the quantity of backlight and the liquid crystal transmittance of the subpixel. JP-A-2005-258404 and JP-A-2005-208425 describe a configuration of a liquid crystal display in which the quantity of backlight is controlled for each of the red (R), green (G), and blue (B) in an independent fashion. The liquid crystal display according to JP-A-2005-258404 includes a controller for simultaneously controlling the change of display data for each color in the liquid crystal display module and the quantity of emission light for each color in the backlight module on the basis of an output signal from a light sensor to sense light emitted from the backlight module and an image signal for each color inputted to the liquid crystal display module for the display thereof. According to JP-A-2005-208425, the liquid crystal display includes a controller to adjust the quantity of backlight. The controller controls operation during a sequence of emission period for each color in the backlight module so that emission start timing and emission end timing are almost equally set for all colors.

### SUMMARY OF THE INVENTION

According to JP-A-2005-258404 and JP-A-2005-208425, the image or picture quality is improved by adjusting the transmittance of each of R, G, and B pixels of the liquid crystal panel and the quantity of R, G, and B light from the backlight module. However, in the description of JP-A-2005-258404 and JP-A-2005-208425, consideration has not been given to influence from crosstalk caused by the difference between the wavelength distribution of the liquid crystal panel transmittance and that of the quantity of backlight. The crosstalk is a phenomenon which takes place when the wavelength distribution varies between the liquid crystal panel transmittance differs and the quantity of backlight as below. The relationship of the multiplication described above cannot be calculated independently for each of red, green, and blue, and hence interaction occurs between red, green, and blue light. This results in deterioration in the picture quality.

It is therefore an object of the present invention to provide a liquid crystal display operating in consideration of the crosstalk between the liquid crystal panel and the backlight.

To achieve the object according to the present invention, there is provided a liquid crystal display including a liquid crystal panel including a pair of substrates, a liquid crystal layer interposed between the substrates, and a plurality of electrodes for applying an electric field to the liquid crystal layer, the panel including a plurality of subpixels formed therein; a backlight module capable of controlling light emission for each color; a storage for storing information of crosstalk caused by mismatching between a wavelength distribution characteristic of light emission from the backlight module and a wavelength distribution characteristic of transmittance of the subpixels; and a controller for adjusting the transmittance of the subpixels and the quantity of light emitted from the backlight module, on the basis of the information in the storage. In another embodiment, the liquid crystal display may be constructed including a module in which the crosstalk information itself is not stored, but information of the wavelength distribution characteristic of light emission from the backlight module and the wavelength distribution characteristic of transmittance of the subpixels is stored to obtain, on the basis of the information, the information of the crosstalk. In this configuration, the wavelength distribution characteristic of light emitted from the backlight module and that of the sub-pixel transmittance may be represented using an isochromatic function to be held in a storage or may be represented as a variable of the quantity of light from the backlight module to stored in a table format.

According to further another embodiment of the present invention, the liquid crystal display may be constructed including a correcting module for correcting mismatching between the wavelength distribution characteristic of light emission from the backlight module and the wavelength distribution characteristic of transmittance of the subpixels and a controller for adjusting the transmittance of the subpixels and the quantity of light emitted from the backlight module, on the basis of correction information created by the correcting module.

In accordance with still another embodiment of the present invention, the liquid crystal display may be constructed in which information of the wavelength distribution characteristic of light emission from the backlight module and the wavelength distribution characteristic of transmittance of the subpixels is stored in an external device. The display includes a data receiving module for receiving the information; a module for obtaining, on the basis of the information received by the data receiving module, information of crosstalk caused by mismatching between the wavelength distribution characteristic of light emission from the backlight module and the wavelength distribution characteristic of transmittance of the subpixels; and a controller for adjusting the transmittance of the subpixels and the quantity of light emitted from the backlight module on the basis of the information of the crosstalk.

In each of the embodiments, the liquid crystal display may be constructed such that the subpixels include subpixels respectively corresponding to red, green, and blue. The backlight module includes tricolor light sources respectively corresponding to red, green, and blue. In this connection, these colors, i.e., red, green, and blue may be arbitrarily defined according to, for example, the RGB color system stipulated by International Commission on Illumination (ICE). Specifically, red, green, and blue are defined as light caused by reference color stimuli of monochrome emission with wavelengths of 700.0 nanometers (nm), 546.1 nm, and 435 nm, respectively. Or, these colors may be prescribed using wavelengths of light emitted from a desired light source or using transmission wavelengths of color filters.

Moreover, in each of the embodiments, the liquid crystal display may include a driver to independently drive the light source of each color in the backlight module. Also, the liquid crystal display may be constructed such that the controller determines the sub-pixel transmittance on the basis of the quantity of light from the backlight module and the information of the crosstalk.

According to the present invention, by use of a display device controlling the quantity of light from the backlight module and the transmittance of the liquid crystal panel, it is possible to implement a liquid crystal display with higher picture quality.

### BRIEF DESCRIPTION OF THE DRAWINGS

FIG. 1 is a block diagram showing a configuration of an image display device according to the present invention.

FIG. 2 is a graph to explain a relationship between the quantity of backlight module and the subpixel transmittance in the multiplication.

FIG. 3A is a diagram to explain a screen layout.

FIG. 3B is a graph showing a relationship between the display power frequency and the display power.

FIGS. 4A to 4C are diagrams showing wavelength distribution characteristics of quantities of RGB backlight and RGB subpixel transmittance.

FIG. 5 is a diagram to explain a change in a color region.

FIG. 6 is a block diagram showing another configuration of an image display device according to the present invention.

FIG. 7 is a block diagram showing still another configuration of an image display device according to the present invention.

FIG. 8 is a block diagram showing a crosstalk correction circuit in an image display device according to the present invention.

FIG. 9 is a block diagram showing a configuration of “personal-computer television”.

FIG. 10 is a diagram showing an example of a layout of a coefficient table.

FIG. 11 is a diagram showing a combination of a discrete data table and interpolation.

FIG. 12 is a diagram showing structure of three-dimensional interpolation.

FIG. 13 is a flowchart showing a pre-processing procedure in a personal computer.

FIG. 14 is a flowchart showing a correction procedure in a personal computer.

FIG. 15 is a diagram showing a layout of a display screen.

FIG. 16 is a diagram showing a configuration of a Light Emitting Diode (LED) driver circuit.

FIG. 17 is a diagram showing a configuration of a Light Emitting Diode (LED) driver circuit.

FIG. 18 is a diagram showing an outline of a liquid crystal display according to the present invention.

### DESCRIPTION OF THE EMBODIMENT

FIG. 18 shows an outline of a liquid crystal display according to the present invention. The display includes substrates 131 and 132 respectively including polarization plates 111 and 112 and a liquid crystal layer 121 interposed between the substrates 131 and 132. On the substrate 131 on the light incidence side, a common electrode 133 and pixel electrodes 135 are formed via an insulation film 137 and a protective insulation film 138 to apply an electric field to the liquid crystal layer 121. Although the electrodes shown in FIG. 18 are configured in “transverse electric field mode”. However, the present invention is not restricted by the configuration. On interfaces of the layer 121, alignment films 122 and 123 are respectively formed.

To a liquid crystal panel 113 thus configured, light is fed from a backlight module 119.

Description has been given of an outline of the liquid crystal display. Next, description will be given in detail of the gist of the present invention, i.e., the configuration to control the backlight module 119 and the liquid crystal panel 113.

### First Embodiment

FIG. 1 shows the basic configuration of an image display device according to the present invention. In the device, an input signal 1 fed to a signal processing circuit 10 is divided into a quantity of RGB backlight 11 and RGB subpixel transmittance 12, which are in a relationship of multiplication with each other in operation. The quantity of RGB backlight 11 is converted by an LED driver circuit 13 into an LED drive signal 15 to resultantly drive the LED backlight 17.

The RGB subpixel transmittance 12 is converted by an LCD driver circuit 14 into an LCD drive signal 16 to drive an LCD panel 18. By finally driving the LED backlight 17 and the LCD panel 18, a display image is formed as a result of the combination of functions of the backlight 17 and the LCD panel 18. The circuits are disposed for each of red, green, and blue and operate independently. Operation to control the RGB subpixel transmittance 12 for red, green, and blue in an independent fashion is almost the same as the operation of the conventional display device. By forming a combination of a liquid crystal subpixel and a color filter, there is conducted an operation like the operation of a switch to select a wavelength distribution.

The present invention has an aspect in which the LED backlight 17 is controlled for each of red, green, and blue in an independent fashion. This basically differs from the backlight using a fluorescent lamp or an LED emitting light of all colors in which the backlight as a white-light source has a fixed wavelength distribution of light emitted therefrom.

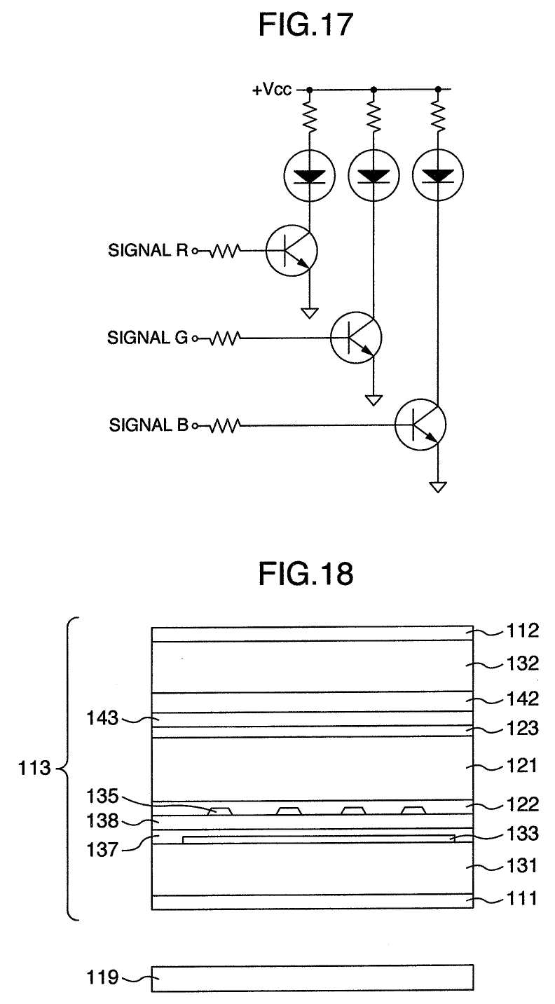

FIG. 16 shows an example of structure of a driver circuit to simultaneously turn RGB tricolor LEDs on. A single drive signal is fed to the driver circuit to simultaneously drive three kinds of LEDs for red, green, and blue. According to a setting value of a resistor connected in series to each LED, the quantity of light emitted from the associated LED can be adjusted. Based on a combination of the setting values, a white point (white light) is set. FIG. 17 shows an example of structure in which each kind of the red, green, and blue LEDs can be independently controlled. For this purpose, there is required a scheme to create three kinds of drive signals. A method of creating these signals will next be described.

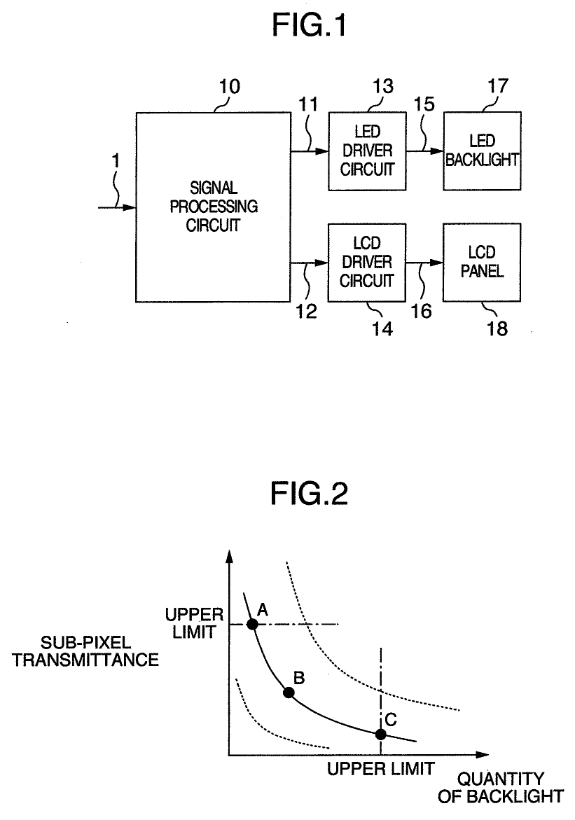

FIG. 2 is a diagram to explain the quantity of RGB backlight and RGB subpixel transmittance, which are in a relationship of multiplication. Assume that the display power is associated with the relationship of multiplication between the quantity of RGB backlight and RGB subpixel transmittance.

As FIG. 2 shows, to obtain the display power with a fixed value, the quantity of RGB backlight and RGB subpixel transmittance are in a relationship of multiplication. In this regard, consideration has not been given to a nonlinear element such as a gamma characteristic. If the gamma characteristic is present, an inverse gamma characteristic is multiplied by the gamma characteristic to convert the characteristic into a linear characteristic. As a result, the relationship holds.

At either one of points A to C shown in FIG. 2, the display power as a result of multiplication between the two variables is fixed within an available signal range. That is, there appears the number of degrees of freedom in the method of selecting the quantity of RGB backlight and RGB subpixel transmittance.

Point A indicates the quantity of light from the backlight for the maximum transmittance within the available signal range. That is, the display power is produced by possibly suppressing the reduction in the quantity of light due to the subpixel transmittance and by using the quantity of backlight to the maximum extent. According to the present invention, point A is adopted to lower power consumption of the backlight as much as possible.

If the screen includes only one single pixel, the condition will be applied only to the pixel. However, the screen actually includes a large number of pixels, and hence description will be first given of the configuration of the screen.

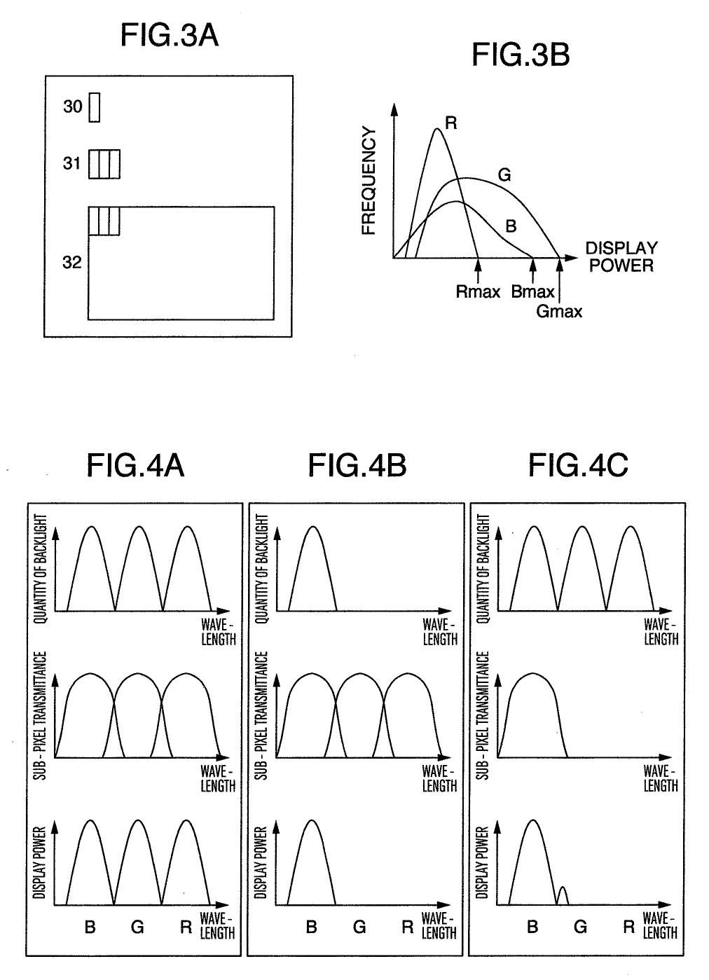

FIG. 3A shows a relationship between the screen configuration and pixels. In FIG. 3A, a subpixel 30 is the minimum unit for which the transmittance is controllable by the liquid crystal device. By adding a color filter, i.e., either one of the red, green, blue filters to the subpixel 30, it is possible to control gradation with wavelength selectivity. By combining three kinds of subpixels of red, green, and blue into a pixel 31, there is obtained the minimum unit capable of conducting color reproduction. By arranging pixels 31 in a plane, there is formed a screen 32.

Although not shown, in a case in which a backlight module is employed to illuminate the screen 32 and the transmittance is controlled for a plurality of subpixels 30 on the screen 32, it is possible to display a color image with smooth gradation throughout the screen.

In the configuration according to the present invention, by setting the minimum quantity of backlight required to display pixels with maximum display power on the screen, the power consumed by the backlight module is minimized.

FIG. 3B shows an example of a histogram of R, G, and B signals on the screen. Maximum values respectively for red, green, and blue are indicated as Rmax, Gmax, and Bmax, which are used to set the quantities of red, green, and blue light from the backlight module in the screen unit. By use of the quantities of backlight set as above, the subpixel transmittance is set on the basis of the relationship of multiplication between the quantities of R, G, and B backlight and the RGB subpixel transmittance. In this way, for the subpixels on the screen, it is possible to appropriately calculate the quantities of R, G, and B backlight and the RGB subpixel transmittance.

Although it is assumed in the description that the backlight module uniformly illuminates areas in the plane, the backlight module may be constructed to have an illumination distribution in the plane. Specifically, the backlight area is subdivided into a plurality of subareas to thereby adjust the quantity of light for each subarea. The backlight area may be subdivided in the transversal or longitudinal stripe unit or in the unit of areas obtained by subdividing the area in grids. According to the present invention, the areas may be freely subdivided. However, for easy understanding, the quantity of backlight is set at a time for the entire screen in the description below. To subdivide the area, a light emitting component may be arranged in a plane beneath the backlight surface or may be disposed on a side surface of a light conductor plate. However, the present invention is not restricted by the method of arranging the light emitting component.

FIGS. 4A to 4C show relationships between the quantity of backlight, the subpixel transmittance, and the display power. For simplicity, the wavelength distribution characteristics of red, green, and blue are represented by convex curves. Particularly, FIGS. 4A to 4C show that the wavelength distribution characteristic generally varies between the quantity of backlight and the subpixel transmittance.

The wavelength distribution of the quantity of backlight is determined according to the wavelength distributions of three kinds of LEDs for red, green, and blue and the drive signals to drive the respective LEDs. The wavelength distribution of the subpixel transmittance depends on the color filters. Since these components are produced in mutually different methods, it is difficult to equalize the wavelength distributions to each other. Description will be given of influence of the difference in the wavelength distribution therebetween onto the display power.

FIG. 4A shows an operation to display white by setting the quantity of backlight and the subpixel transmittance to the maximum values, respectively.

FIG. 4B shows an operation to display blue. The quantity of backlight is set to the maximum value only for blue and the subpixel transmittance is set to the maximum value for red, green, and blue, respectively. As a result of the driving operations, the quantity of backlight for blue (B) is used as the display power.

FIG. 4C shows an operation to display blue. The quantity of backlight is set to the maximum value for red, green and blue and the subpixel transmittance is set to the maximum value only for blue. The display power in this situation is a combination of the wavelength distributions of the quantities of red, green, and blue backlight and that of the blue subpixel. The emission wavelength distribution of the subpixel B is other than that of blue backlight and extends to the emission wavelength distribution of green backlight. Resultantly, the quantity of light of the green backlight transmits through the blue subpixel to appear in the display power. This phenomenon is called crosstalk, which implies leakage of color between red, green, and blue.

In this way, the wavelength distribution of blue thus displayed varies depending of selection of the display method. The variation in the wavelength distribution also takes place due to the crosstalk when red or green is displayed.

In summary, the leakage of color, i.e., crosstalk occurs if there exits two conditions. First, the backlight is controlled for red, green, and blue in an independent fashion. Second, the RGB wavelength distribution varies between the backlight and the subpixel.

For the phenomenon, there also exists a factor similar to the first factor described above, namely, a change in the emission quantity due to, for example, a temperature characteristic and a life characteristic of the light emitting component. This change is inherently other than a change to be controlled for the above purpose. However, the quantity of emission light varies in this situation like when the change is intentionally controlled for the purpose. While description will not be given in detail of the temperature characteristic and the life characteristic of the light emitting component, it is possible to use the same scheme to solve the problem associated with these characteristics.

In the display device, the primary colors of red, green, and blue are the basic characteristics to be inherently fixed. However, the primary colors change due to occurrence of the crosstalk, which deteriorates the picture or image quality.

According to an aspect of the present invention, the primary colors are fixed by correcting the crosstalk to thereby sustain the picture quality, which will be described later.

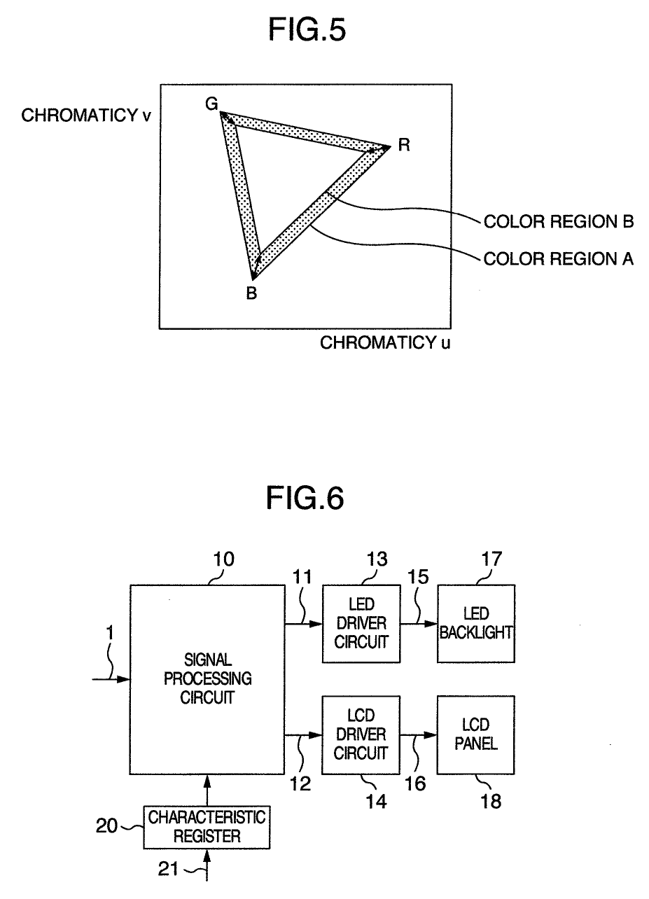

FIG. 5 shows a displayable color region available to display and image, the region being formed by linking chromaticy points of the primary colors by straight lines. Region A for which the chromaticy points are at the outer-most positions corresponds to monochrome emission of the RGB backlight. Region B for which the chromaticy points are at the inner-most positions corresponds to all-color emission of the RGB backlight.

When the quantities of red, green, and blue backlight are set using the maximum values Rmax, Gmax, and Bmax respectively of red, green, and blue as shown in FIG. 3B, the combination of red, green, and blue varies according to the image on the screen. Specifically, the chromaticy points of the primary colors R, G, B move in the area defined by the maximum region A and the minimum region B. Since the color produced by the combination of the primary colors also changes, it is not possible to reproduce the color in a stable state.

The crosstalk correction aims at stabilizing the color reproduction by suppressing the change in the positions of the chromaticy points. For this purpose, the chromaticy points of stable primary colors are set in the minimum color region B according to the present invention. The color area which changes depending on the setting of the quantities of red, green, and blue backlight components is mapped onto the stable color region B to thereby carry out the crosstalk correction.

The improvement in the picture quality due to the change in the backlight quantity results in an advantage in which the leakage is reduced when the liquid crystal transmittance is set to off. In general, even if the liquid crystal transmittance is set to off, there slightly appears the leakage of light depending on cases. By reducing the backlight quantity on the basis of the input video signal, the quantity of leakage light lowers because the quantity of emission light is reduced even if the liquid crystal transmittance in the off state is kept unchanged. Therefore, the ratio of the display power between when the liquid crystal transmittance is in the on state and when the liquid crystal transmittance is in the off. This makes it possible to appropriately display a clear screen image with a bright part and a clearly dark part.

In the basic procedure to process signals according to the present invention, crosstalk coefficients are calculated for the crosstalk correction on the basis of the quantities of backlight of red, green, and blue set in the screen unit and then the subpixel transmittance is corrected using the crosstalk coefficients, to thereby map the unstable color area onto the stable color region.

Prior to the crosstalk correction method, description will be given of the principle of occurrence of the crosstalk using expressions. The distribution characteristic in the wavelength direction is converted into numeric data items using an isochromatic function to establish a relationship between the data items. The isochromatic function is well known in the field of chromatics and includes three kinds of wavelength sensitivity curves obtained using a visual sense characteristic.

The characteristic of blue which can be perceived by the visual sense can be represented by three numeric values (X, Y, Z), specifically, by multiplying the wavelength distribution of the emission or transmittance by three kinds of wavelength sensitivity curves X(λ), Y(λ), and Z(λ), where X indicates a wavelength.

$$( \begin{matrix}X rr & Y rr & Z rr \\ X rg & Y rg & Z rg \\ X rb & Y rb & Z rb\end{matrix} ) \\ ( \begin{matrix}X g r & Y g r & Z g r \\ X gg & Y gg & Z gg \\ X gb & Y gb & Z gb\end{matrix} ) \\ ( \begin{matrix}X br & Y br & Z br \\ X bg & Y bg & Z bg \\ X bb & Y bb & Z bb\end{matrix} ) \qquad ( 1 )$$

The characteristic of transmittance of red light through the color filter of red subpixel is represented as (Xrr,Yrr,Zrr) by use of an isochromatic function XYZ. Similarly, the characteristics of transmittance of red light through the color filters respectively of green and blue subpixels are represented as (Xrg,Yrg,Zrg) and (Xrb,Yrb,Zrb), respectively. By combining these components with each other, there is obtained a coefficient matrix of three-by-three size. Similarly, the characteristics of emission of green and blue can be represented by a coefficient matrix of three-by-three size.

$$rLCD \cdot ( rLED gLED bLED ) \cdot ( \begin{matrix}X rr & Y rr & Z rr \\ X rg & Y rg & Z rg \\ X rb & Y rb & Z rb\end{matrix} ) \\ gLCD \cdot ( rLED gLED bLED ) \cdot ( \begin{matrix}X g r & Y g r & Z g r \\ X gg & Y gg & Z gg \\ X gb & Y gb & Z gb\end{matrix} ) \\ bLCD \cdot ( rLED gLED bLED ) \cdot ( \begin{matrix}X br & Y br & Z br \\ X bg & Y bg & Z bg \\ X bb & Y bb & Z bb\end{matrix} ) \qquad ( 2 )$$

The coefficient matrix is multiplied by a drive signal (rLED,gLED,bLED) to control emission of red, green, and blue components. The result of the multiplication is multiplied by the red subpixel transmittance rlcd through the liquid crystal device to resultantly obtain the display power for red. Similarly, for green and blue, the coefficient matrices respectively thereof are multiplied respectively by the respective transmittance values glcd and blcd to resultantly obtain the display power values for green and blue, respectively. As can be seen from expression (2), the three light components of red, green, and blue contribute to the display power of each primary color, which causes the crosstalk.

$$( rin gin bin ) \cdot ( \begin{matrix}X r & Y r & Z r \\ X g & Y g & Z g \\ X b & Y b & Z b\end{matrix} ) \qquad ( 3 )$$

Assume that the display characteristic of the display device is represented as (Xr,Yr,Zr) for red, (Xg,Yg,Zg) for green, and (Xb,Yb,Zb) for blue. The display device has an object to drive the characteristic thereof by use of a video signal (rin,gin,bin) inputted thereto. That is, the target value thereof is represented by expression (3).

$$( rLCD gLCD bLCD ) = ( rin gin bin ) \cdot ( \begin{matrix}X r & Y r & Z r \\ X g & Y g & Z g \\ X b & Y b & Z b\end{matrix} ) \cdot {( \begin{matrix}rLED \cdot ( \begin{matrix}X rr & Y rr & Z rr \\ X rg & Y rg & Z rg \\ X rb & Y rb & Z rb\end{matrix} ) + \\ gLED \cdot ( \begin{matrix}X g r & Y g r & Z g r \\ X gg & Y gg & Z gg \\ X gb & Y gb & Z gb\end{matrix} ) + bLED \cdot ( \begin{matrix}X br & Y br & Z br \\ X bg & Y bg & Z bg \\ X bb & Y bb & Z bb\end{matrix} )\end{matrix} )}^{- 1} \qquad ( 4 )$$

It is only required to calculate the drive signal such that the total of expression (2) matches the target value represented by expression (3). The drive signal (rLED,gLED,bLED) to set the backlight quantity is set according to signal values on the screen. In a case in which the screen is uniformly illuminated, the drive signal (rLED,gLED,bLED) is first set in the screen unit and then the liquid crystal transmittance (rlcd,glcd,blcd) is calculated. In an expression “total of expression (2)=target value represented by expression (3)”, the liquid crystal transmittance (rlcd,glcd,blcd) is moved to the left side and the remaining elements on the left side are moved to the right side to thereby obtain expression (4). In the components of expression (4), the third term on the right side is an inverse matrix including the backlight drive signal. The inverse matrix is calculated on the basis of the backlight drive signal. The constant of the second term on the right side is then multiplied by the input video signal to obtain the liquid crystal transmittance on the left side.

$$( rLCD gLCD bLCD ) = ( rin gin bin ) \cdot ( \begin{matrix}C rr & C rg & C rb \\ C g r & C gg & C gb \\ C br & C bg & C bb\end{matrix} ) \qquad ( 5 )$$

Expression (5) represents a relationship between the liquid crystal transmittance and the input video signal according to the coefficient matrix on the basis of the backlight quantity. The crosstalk can be corrected by conducting a correction for the liquid crystal transmittance using the coefficient C. Since the input video signal changes in the pixel unit, the right side of expression (5) is to be calculated for each pixel. The right side may be calculated, for example, as follows. First, the calculation is conducted according to expression (5). Second, results of the calculation are listed for all combinations of (rLED, gLED, bLED) in a table in advance. Third, a table including results of combinations selected from the combinations at a predetermined interval is combined with operation of interpolation. For the first method, there is prepared a circuit configuration to calculate an inverse matrix.

For the second method, there is required a memory to store the results of calculation for all combinations of (rLED, gLED, bLED). The third method is implementable by combining a circuit smaller than that of the first method with a memory having a smaller capacity than that of the memory of the second method.

As above, according to an aspect of the present invention, the change in the color region due to the crosstalk is corrected by executing signal processing. As described above, one of the conditions to cause the crosstalk is that the wavelength distribution characteristic varies between the backlight and the subpixels. That is, the wavelength distribution varies depending on the light emitting component of the backlight and the color filters of the subpixels. According to the present invention, the crosstalk is corrected by preparing information regarding the wavelength distribution.

The target set by the input video signal is represented by a setting value independent of the wavelength distributions of the backlight and the color filters. Therefore, by setting a displayable color region available for the display device or an achromatic color called “white point” through a target setting operation, it is possible that the signal processing module of the present invention simultaneously conducts the crosstalk correction and displays at the same time the color region displayable by the display device and the color of the white point in a stable state. The target can be set, for example, to produce a picture or an image reflecting the taste of viewers of the display device.

### Second Embodiment

According to an aspect of the present invention, to execute signal processing for the crosstalk correction, the image display device shown in FIG. 1 includes a characteristic register 20 as a storage to store information regarding the wavelength distribution characteristics of the backlight quantity and the subpixel transmittance as shown in FIG. 6.

The characteristic register 20 is a storage capable of conducting data writing and reading operations. As a characteristic signal 21 to be written in the register 20, there may be employed, for example, the wavelength distribution characteristics of the backlight LED and the subpixel color filter; values obtained by multiplying the wavelength distributions of the backlight LED and the subpixel color filter by the isochromatic function; or data indicating a relationship between the RGB backlight quantities and the crosstalk coefficients.

Timing to write the characteristic signal 21 in the characteristic memory 20 is set depending on the device configuration. For example, in a device configuration in which all circuits used for the display operation are mounted in one housing, it is only required to write the characteristic signal 21 in the characteristic memory 20 when the circuits are assembled in the housing. Or, in a device configuration in which parts of, for example, the backlight module are replaceable, it is desirable to write the characteristic signal 21 of the parts thus installed in the housing in the characteristic memory 20. Therefore, the characteristic memory 20 has a memory function to rewrite data and to keep data written therein. Specifically, there may be employed, for example, a flash memory, an Electrically Programmable Read Only Memory (EPROM), and a Static Random Access Memory (SRAM) using a battery to back up the memory. The characteristic signal 21 written in the characteristic memory 20 is used for the crosstalk correction.

Description will now be given of an example of the signal processing procedure including the crosstalk correction. In a first step, image data is inputted to calculate the maximum values Rmax, Gmax, and Bmax for red, green, and blue on the screen. In a second step, the red, green, blue backlight quantities on the screen are set. In a third step, the RGB subpixel transmittance values on the screen are set for red, green, and blue, respectively. In a fourth step, data indicating a relationship between the RGB backlight quantities and the crosstalk coefficients is read from the characteristic register. In a fifth step, crosstalk coefficients are calculated on the basis of the RGB backlight quantities. In a sixth step, the RGB subpixel transmittance values are corrected by use of the crosstalk coefficients. In a seventh step, the RGB backlight quantities and the corrected RGB subpixel transmittance values are outputted.

In the fourth step, the number of combinations of three kinds of RGB backlight quantities is 224 if eight bits are assigned to each of red, green, and blue. That is, the correction coefficients include a large amount of data items. To employ a data format to reduce the amount of data, either one of three methods is available as follows.

(1) A Look Up Table (LUT) is employed to keep therein a relationship between the quantities of input RGB backlight and the output correction coefficients. The table can be reduced in size by using discrete numeric values as the input values and by interpolating the output values.

(2) Polynomial approximation is employed. The RGB backlight quantities are designated as variables. By use of a polynomial, a relationship in which an operation result is a correction coefficient is approximated by a polynomial. The higher the degree of the polynomial, the higher the accuracy of the approximation. The operation of the polynomial requires multiplication with high precision.

(3) Emulation is employed by use of an emulator module which numerically emulates the principle of occurrence of the crosstalk. For example, by using expression (1) as a model, the coefficients to correct the crosstalk are calculated and are employed in the correction.

Description will now be specifically given of the device configuration for the first method according to an aspect of the present invention.

The quantities of red, green, blue backlight are represented as three coordinate axes and the continual division is conducted to store the resultant coefficients at division points in a table. As described above, the coefficients for the crosstalk correction can be represented in a three-by-three matrix in which each coefficient is a variable which depends on the backlight quantity of red, green, or blue. As FIG. 10 shows, there is prepared for each coefficient a table from which a coefficient value is read using the RGB backlight quantity as an index. The coefficients thus prepared are coefficients C as variables of the backlight quantities represented by expression (5).

If the setting of RGB backlight quantities is divided by eight bits, the number of combinations resulted from the division is 16777216 (256³). If the setting is divided by four bits, the number of combinations is 4096 (16³). The table size can be remarkably reduced in the latter case as compared with the former case. However, in the latter case, it is not possible to store the coefficients at more precise division points in the coordinate system. Therefore, data items at intermediate points between the grid points are calculated by interpolation using data items at the grid points.

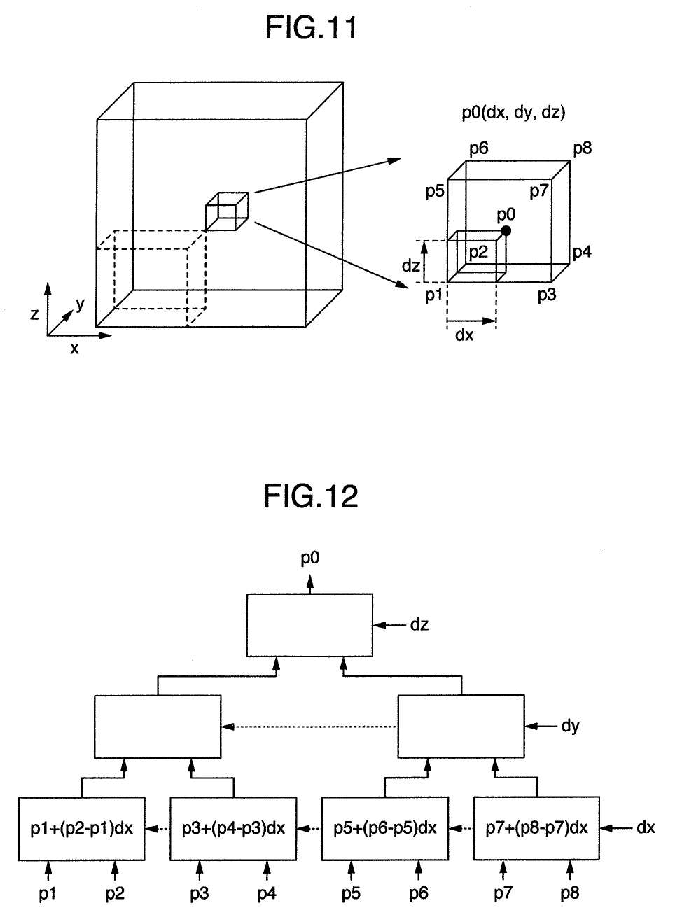

FIG. 11 shows the continual or discrete division of a space along three coordinate axes in a three-dimensional coordinate system. Coefficients are assigned to grids resultant from the division, and then interpolation is carried out to further divide the coordinate space in each grid.

$$p 0 = ( p 1 + ( p 2 - p 1 ) dx ) + ( ( p 1 + ( p 2 - p 1 ) dx ) - ( p 3 + ( p 4 - p 3 ) dx ) ) dy + ( ( p 5 + ( p 6 - p 5 ) dx ) + ( ( p 5 + ( p 6 - p 5 ) dx ) - \\ ( p 7 + ( p 8 - p 7 ) dx ) ) dy - ( p 1 + ( p 2 - p 1 ) dx ) + ( ( p 1 + ( p 2 - p 1 ) dx ) - ( p 3 + ( p 4 - p 3 ) dx ) ) dy ) dz \qquad ( 6 )$$

The present invention does not limit the interpolation method. Expression (6) is an example of the expression for interpolation to interpolate data items between the grids using a linear function. The value of inner point p0 of a grid is calculated on the basis of numeric values p1 to p8 of eight grid points enclosing inner point p0. Assuming that the grid has an edge having a length of one, the internal position of internal point p0 is represented as (dx, dy, dz), where dx, dy, and dz are each equal to or less than the edge length. The coefficients of discrete grid points are read from the table according to high-order bits of the signal indicating the backlight quantity. The interpolation is then carried out using the coefficients according to low-order bits of the signal to thereby obtain coefficient values with high precision. In this connection, expression (6) is a combination of basic expressions each of which is “pC=pA+(pB−pA)·dxyz”, where A, B, and C indicate kinds of signals and dxyz indicates either one of dx, dy, and dz. FIG. 12 shows structure of components or terms of expression (6) in which each frame represents an operation element, the element receiving as inputs thereto pA and pB to produce pC as an output therefrom. Coefficients at positions of grid points are set as inputs to the frames at the bottom of the tree structure of FIG. 12. By conducting the computation upwards through the frames at the respective levels while alternately changing the setting of dx, dy, and dz indicating the internal positions in the grid, it is possible to calculate the coefficient value in the space enclosed by the grid points. As FIG. 12 shows, the results of interpolation can be obtained by repeatedly calculating the basic expression seven times. According to the present invention, the interpolation is carried out for nine elements of the three-by-three correction coefficient matrix.

As above, by preparing a circuit or a software module to execute a regular operation at a high speed and by repeatedly conducting the operation by use of the circuit or software module, there can be implemented a simple, high-speed module to achieve the purpose.

The operation of the expression for interpolation is required to be conducted only when a change occurs in the backlight quantity. Timing of the change in the backlight quantity depends on the setting of the backlight quantities and the calculation method. The present invention does not limit the timing.

According to an aspect of the present invention, the coefficients at the continual or discrete grid points associated with the panel characteristic are prepared in advance. To solve the problem of the crosstalk correction, which has not been considered in the prior art, by use of a practical circuit size and at a feasible execution speed, the numeric values of the coefficients are produced on the basis of the crosstalk correction. According to an aspect of the present invention, for easy communication of the coefficient values, the coefficient values are represented in a data layout to be easily communicated between units and components.

Specifically, by adding a header including description of such items as a title, the contents of numeric values, a creation date of numeric values, a kind of the coefficient, and a creator to the numeric values, communicability of the numeric values is remarkably increased. For example, it is possible to add a medium having recorded the data to the display device or it is possible to transfer the data via a network.

Even if the light emitting component included in the backlight module is replaced by a new light emitting component, for example, for maintenance and management of the system, the picture quality can be sustained through an appropriate correction by use of the characteristic of the new light emitting component inputted using the operation described above.

### Third Embodiment

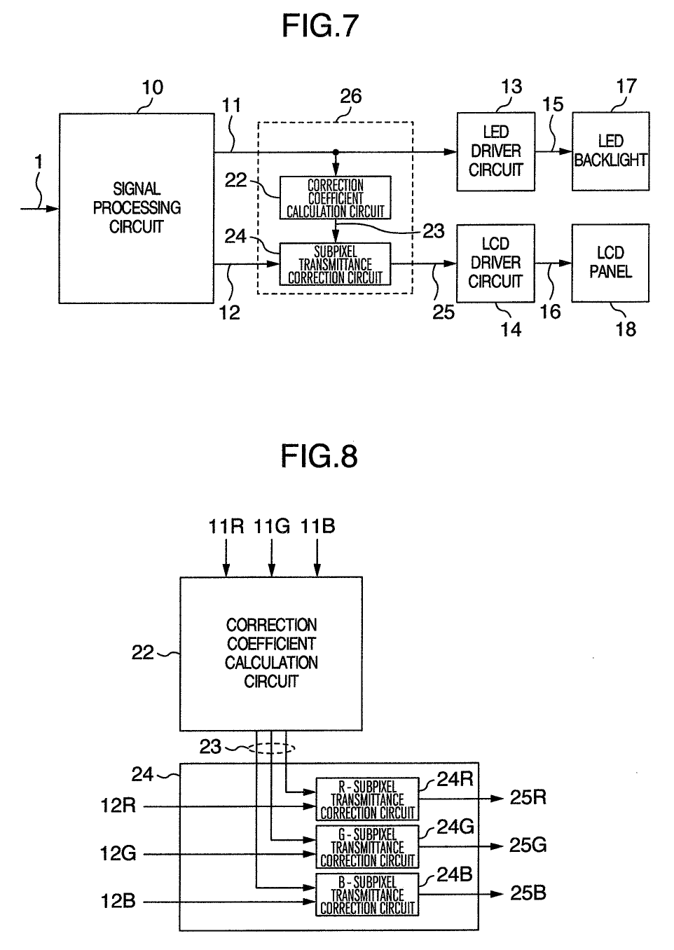

FIG. 7 shows a configuration of a circuit to carry out the signal processing procedure. Description will be given of the circuit centered on a crosstalk correction circuit 26 as the correcting module for the crosstalk correction. The other configurations of FIG. 7 are almost the same as those of FIG. 1. The RGB backlight quantity 11 is calculated on the basis of the maximum values on the screen to be outputted to a correction circuit 26. A correction coefficient calculation circuit 22 receives the backlight quantity 11 to output a correction coefficient 23 therefrom. A subpixel transmittance correction circuit 24 corrects the subpixel transmittance 12 on the basis of the correction coefficient 23 to output corrected subpixel transmittance 25 therefrom.

FIG. 8 shows a configuration of the crosstalk correction circuit using the Look Up Table (LUT) in which the correction coefficient calculation circuit 22 includes a memory, which operates as LUT for the crosstalk correction.

The data of LUT may be beforehand prepared as LUT data using the characteristic signal 21 itself or may be calculated using an approximation expression according to the characteristic signal 21 written in the characteristic register 20 shown in FIG. 6.

In the table shown in FIG. 8, an RGB backlight quantity (11R, 11G, 11B) is employed as an address to access the memory to read data therefrom, and readout data obtained from the memory is outputted as the correction coefficient 23. In an RGB subpixel transmittance correction circuit (24R, 24G, 24B), a correcting operation is conducted using the correction coefficient 23 and RGB subpixel transmittance (12R, 12G, 12B) to resultantly output corrected RGB subpixel transmittance (25R, 25G, 25B).

By using the look-up table according to an aspect of the present invention, there can be conducted an arbitrary conversion of data at a high speed. It is also possible to write data in the memory so that data also including data having a characteristic other than that of the crosstalk, for example, the gamma characteristic is converted at a time.

The characteristic register 20 may be specifically an approximation polynomial to calculate the correction coefficient. In the configuration, the characteristic signal 21 to be written in the characteristic register 20 is a coefficient value of an approximation polynomial. A polynomial may be formed using a combination of, for example, a power function, a sine function, and a cosine function. Assume, for example, that the coefficient is represented as ABCD and the variable is X. The calculation is conducted as Y=(A+B·X+C·X·X+D·X·X·X), where the dot indicates multiplication.

To conduct the crosstalk correction using polynomial approximation in the configuration of FIG. 8, the correction coefficient calculation circuit 22 includes a polynomial operation circuit which receives as an input thereto the RGB backlight quantity (11R, 11G, 11B) and which outputs a correction coefficient. The coefficient 23 calculated as a result is fed to the subpixel transmittance correction circuit 24. The correction circuit 24 conducts operation for the RGB subpixel transmittance (24R, 24G, 24B) and the coefficient 23 to thereby output a corrected RGB subpixel transmittance (25R, 25G, 25B). Thanks to the calculation for the corrected coefficient using a polynomial, the memory required in the method of the look-up table can be dispensed with.

### Fourth Embodiment

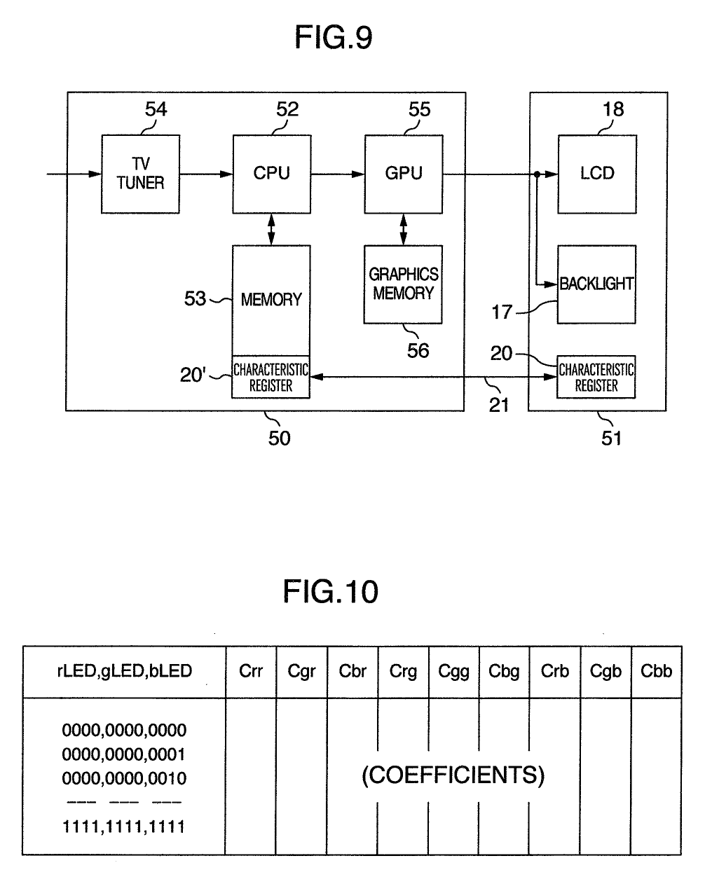

FIG. 9 shows a configuration of “personal computer television” including a personal computer 50 and a display panel 51 connected via a cable thereto. The personal computer 50 as an external module primarily includes a Central Processing Unit (CPU) 52, a memory 53, a hard disk drive, not shown, a graphics processor unit (GPU) 55, and a graphics memory 56 to display an image. The display panel 51 includes a backlight module 17 and an LCD panel 18.

Assume that the CPU 52 of the personal computer 50 executes signal processing to control the backlight module 17 of the display panel 51 for each of red, green, and blue in an independent fashion. To execute signal processing for the wavelength distribution such as crosstalk correction processing, it is required to send data regarding the wavelength distributions of the backlight module 17 and the subpixel color filter of the display panel 51 from the display panel 51 to the personal computer 50. It is desirable that a display panel 51 of a desired type is connectible to the personal computer 50.

The display panel 51 includes a characteristic register 20 to store the wavelength distribution characteristics of the LCD panel and the backlight module as internal components of the display panel. There is also arranged a unit to transfer the characteristic signal 21 regarding the wavelength distribution of the display panel 51 therefrom to the personal computer 50. The computer 50 uses as a characteristic register 20′ a part of the area of the memory 53.

According to an aspect of the present invention, there are prepared the display panel 51 and the personal computer 50 respectively including the characteristic registers 20 and 20′ storing data regarding the wavelength distributions as well as a data communication unit to communicate data between the characteristic registers 20 and 20′.

The communication of data between the characteristic registers 20 and 20′ is conducted when the type of the display panel 51 is changed, when system is powered, or in response to an indication from an operator. For example, data regarding the wavelength distributions of the display panel 51 may be transferred from the panel 51 to the personal computer 50 via a signal capable used to send an image signal from the computer 50 to the panel 51. Or, it is also possible to connect the personal computer 50 to the display panel 51 using a general interface of, for example, a Universal Serial Bus (USB) to transmit the data from the panel 51 to the computer 50.

The personal computer 50 processes signals in a signal processing procedure as follows. First, the computer 50 receives an image signal as an input thereto. Second, the computer 50 calculates the backlight quantity in the screen unit and the liquid crystal transmittance for each subpixel. Third, the computer 50 calculates the crosstalk correction coefficient on the basis of the backlight quantity. Fourth, the computer 50 executes processing to correct the liquid crystal transmittance. Fifth, the computer 50 transmits the backlight quantity and the liquid crystal transmittance to the display panel 51. Sixth, display power is obtained. These signal processing steps may be conducted under control of a program by use of the CPU 42 of the personal computer 50.

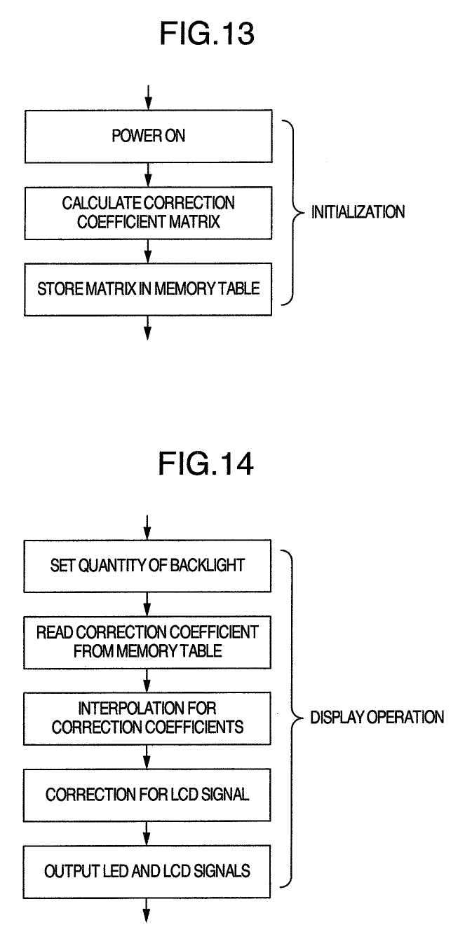

The calculation of the crosstalk correction coefficient in the third step may be implemented on the basis of a combination of the discrete data table and the interpolation as described above. For example, as FIG. 13 shows, during the preparation period after the system is powered, coefficients are prepared in the memory of the personal computer, each of the coefficients being associated with an index including a combination of the backlight quantities. As can be seen from FIG. 14, according to a setting values of backlight quantities set for the table search, the system searches the table to obtain a readout result. Based on the result, the system conducts interpolation of data to immediately obtain a correction coefficient. The signal processing may be executed by a CPU as well as a graphic processor unit (GPU).

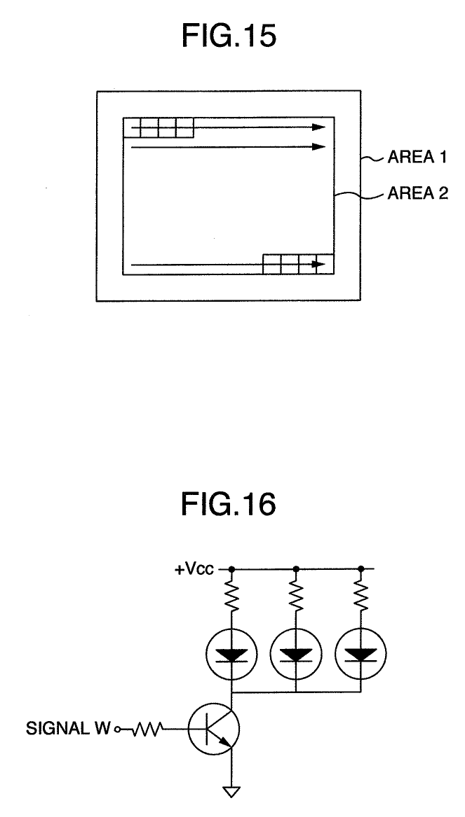

In the fifth step, the data is transmitted using a signal format different from the conventional signal format. For example, as FIG. 15 shows, the display screen includes a video period to display a screen and a flay-back period to thereby sustain compatibility with the Cathode-Ray Tube (CRT) operation. In the data transmission, the backlight quantity in the screen unit is set during the flay-back period of the screen, and the liquid crystal transmittance for each pixel is set during the video period. Or, it is also possible to superimpose data on the signals of pixels during the video period in a way in which the data cannot be easily perceived by eyes.

In this way, the signal can be transmitted while retaining the electric and physical characteristic of the signal cable. If there is disposed a unit to confirm the device type, it is possible to change the signal transmission mode for the device type, for example, a CRT, and hence the display power can be appropriately obtained.

In the signal processing by the personal computer 50, it is convenient to treat the backlight quantity in the screen unit and the liquid crystal transmittance for each pixel in the form of signals of screen pixels. As a specific advantage, the backlight quantity and the liquid crystal transmittance can be read or written by a program as the pixel data on the graphics memory 56. These information items can be transmitted as pixel data to the display panel 51.

Description will be given of the signal format of the characteristic signal 21 and the configuration for the signal interface. For the most basic signal format, there may be used a method to describe, directly in the form of data, the wavelength distribution characteristics of the backlight LEDs and the subpixel color filters. Since the amount of data increases for the distribution characteristics, it is possible to convert the data into numeric data. Specifically, the data is multiplied an isochromatic function to resultantly obtain the numeric data. The isochromatic function includes three kinds of wavelength characteristics called X, Y, and Z on the basis of the wavelength distribution characteristic of an angle of view. In use the signal format, the data format includes a data item indicating selection of the signal format and specific data following the data item. This makes it possible to discriminate the data type in use of the signal on the reception side.

### Fifth Embodiment

Description has been given of operation in which the backlight module emits light with predetermined brightness and a uniform quantity of light. However, the uniformness in the quantity of light may change depending on structure of the backlight module. For example, it is possible that the light emitting component such as an LED is disposed on a side surface of the backlight plane and the backlight plane guides light from the LED to reflect the light toward the front side using an appropriate method, to thereby illuminate the liquid crystal screen. In such configuration with the light emitting component arranged on the side surface, luminance in the direction toward the front surface is strong in the vicinity of the side surface and is weak in a central region apart from the side surface. This may cause uneveness in luminance on the screen and hence deteriorates the picture quality of the display device. Similarly, when the light emitting component is disposed just beneath the backlight, the uneveness occurs in luminance if scattering of light is insufficient. The uneveness in luminance also includes nonuniformity in color when LED chips such as red, green, and blue chips having mutually different emission wavelengths are used in combination with each other. The nonuniformity takes place because the light beams emitted from the respective chips are not sufficiently mixed with each other. Such insufficiency takes place in the optical color mixing depending on cases, for example, if the distance between the light emitting component and the target of light emission is short or if the gap between the chips with mutually different emission colors is wide.

However, the uneveness in luminance depends on the backlight structure and the driving condition to drive each light emitting component. Therefore, by conducting measurement of associated values in advance, there can be obtained a characteristic value corresponding thereto. For this purpose, there is disposed, for example, a unit which stores the setting values of drive signals respectively of LEDs disposed on the side surface as well as the backlight quantity beforehand measured for each pixel position in a plane corresponding to the setting values, for example, in the format of a table or in a method using an approximation function. In an actual image display operation, the system reproduces the light quantity for each pixel position on the display screen, the light quantity being measured when the drive signals are set for the LEDs on the side surface. The table is implementable using a memory storing the conditions as indices and associated numeric data items. Or, there may be employed a combination of a table and interpolation, the table including numeric data items for the respective discrete conditions. Or, if the uneveness is represented by an approximation function including a combination of, for example, trigonometric functions, the table needs only to store the coefficients indicating weights of respective terms of the functions. In this way, it is possible to construct a unit which receives as its input the driving condition such as a voltage or a current for each light emitting component and which outputs the backlight quantity associated with the input.

On the basis of the backlight quantity thus reproduced, the signal processing can be executed for the crosstalk compensation. The signal processing is also a procedure to calculate the liquid crystal transmittance based on the input video signal and the backlight quantity. This also leads to an advantage of the signal processing to compensate for the uneveness in the backlight. There is simultaneously obtained an advantage as the signal processing to set the display color region and the white point.

### Sixth Embodiment

Description has been given of a configuration in which the wavelength distribution of the backlight module driving the red, green, and blue light emitting components in an independent fashion changes. In this connection, it is to be understood that a similar crosstalk factor exists in other than the case including three kinds of wavelength distributions for the red, green, and blue light emitting components, namely, in a case including four kinds of wavelength distributions for four kinds of colors. In this case, it is only required to produce a matrix including the wavelength distributions of color filters added to the liquid crystal panel to control the transmittance and the XYZ values associated with combinations of the wavelength distributions of four kinds, and to prepare a calculation formula to calculate the liquid crystal transmittance as a target of the display XYZ value corresponding to the input signal.

Description will now be given of a situation in which the light emitting component emits one kind of single light, i.e., white light. The light emitting component may be constructed such that the red, green, and blue light emitting elements in the component are simultaneously driven by one single signal, to thereby emit white light. Or, the white light emitting component may be constructed using a combination of an ultraviolet ray emitting element and a white light emitting fluorescent lamp. Although the white wavelength distribution is inherently fixed in either construction, the wavelength distribution fluctuates depending on a characteristic of an actual component in some cases. For example, in the former construction described above, the relationship between the drive signal and the emission light quantity varies between the red, green, and blue light emitting elements. If the ratio between the quantities of red, green, and blue emission light changes, the white wavelength distribution varies. Also, if the relationship between the temperature and the quantity of emission light varies between the red, green, and blue light emitting elements, there occurs fluctuation in the wavelength distribution of white light produced by combining the light of three colors.

In a case in which the driving operation is conducted to make the quantity of light emitted from the white backlight variable, the wavelength distribution of white light varies if there exists the factor described above. The occurrence of crosstalk is one of the causes of the picture quality deterioration due to such variation.

It goes without saying that the scheme of the present invention is available to correct the change in the color of the display screen due to the variation in the wavelength distribution. Specifically, the display signal is corrected by establishing a correspondence between the backlight quantity (or the RGB drive signal) and the coefficient to correct the liquid crystal drive signal for the correction of the change in color. If a change exists in the quantity of light depending on a position in the plane of the backlight, there is prepared a unit which beforehand measures a characteristic value regarding the change in the light quantity corresponding to the position and which stores the characteristic value therein. According to the position of the scanning line for the screen display, the change in the liquid quantity depending on the position is read from the storage to execute processing to correct the liquid crystal transmittance. In this way, the crosstalk compensation and the correction of the uneveness in the quantity of the backlight are carried out to advantageously sustain the high picture quality.

To display a further darker screen, the backlight quantity is reduced. This lowers the quantity of light leaking from the liquid crystal panel to thereby display the dark screen with high fidelity.

The present invention is also applicable to a liquid crystal display controlling the backlight quantity for each of red, green, and blue in an independent fashion. Also, present invention is applicable to a television set, a personal computer, a monitor, and the like using such liquid crystal display.

It should be further understood by those skilled in the art that although the foregoing description has been made on embodiments of the invention, the invention is not limited thereto and various changes and modifications may be made without departing from the spirit of the invention and the scope of the appended claims.

1. A liquid crystal display, comprising:
a liquid crystal panel comprising a pair of substrates, a liquid crystal layer interpolated between the substrates, and a plurality of electrodes for applying an electric field to the liquid crystal layer, the panel including a plurality of subpixels formed therein;
a backlight module capable of controlling light emission for each color;
storage means for storing information of crosstalk caused by mismatching between a wavelength distribution characteristic of light emission from the backlight module and a wavelength distribution characteristic of transmittance of the subpixels; and
a controller for adjusting the transmittance of the subpixels and the quantity of light emitted from the backlight module, on the basis of the information in the storage means.

2. A liquid crystal display according to claim 1, wherein:
the plural subpixels include subpixels of three colors corresponding to red, green, and blue; and
the backlight module includes light sources of three colors corresponding to red, green, and blue.

3. A liquid crystal display according to claim 1, further comprising driving means for driving the light sources of the respective colors in an independent fashion.

4. A liquid crystal display according to claim 1, wherein the controller determines the transmittance of the subpixels on the basis of the quantity of light emitted from the backlight module and the information of the crosstalk.

5. A liquid crystal display, comprising:
a liquid crystal panel comprising a pair of substrates, a liquid crystal layer interposed between the substrates, and a plurality of electrodes for applying an electric field to the liquid crystal layer, the panel including a plurality of subpixels formed therein;
a backlight module capable of controlling light emission for each color;
storage means for storing a wavelength distribution characteristic of light emission from the backlight module and a wavelength distribution characteristic of transmittance of the subpixels;
means for obtaining, on the basis of information in the storage means, information of crosstalk caused by mismatching between the wavelength distribution characteristic of light emission from the backlight module and the wavelength distribution characteristic of transmittance of the subpixels; and
a controller for adjusting the transmittance of the subpixels and the quantity of light emitted from the backlight module, on the basis of the information of the crosstalk.

6. A liquid crystal display according to claim 5, wherein:
the plural subpixels include subpixels of three colors corresponding to red, green, and blue; and
the backlight module includes light sources of three colors corresponding to red, green, and blue.

7. A liquid crystal display according to claim 5, further comprising driving means for driving the light sources of the respective colors in an independent fashion.

8. A liquid crystal display according to claim 5, wherein the controller determines the transmittance of the subpixels on the basis of the quantity of light emitted from the backlight module and the information of the crosstalk.

9. A liquid crystal display according to claim 5, wherein the storage means stores the wavelength distribution characteristic of light emission from the backlight module and the wavelength distribution characteristic of transmittance of the subpixels, the wavelength distribution characteristics being represented using an isochromatic function.

10. A liquid crystal display according to claim 5, wherein the storage means stores the wavelength distribution characteristic of light emission from the backlight module and the wavelength distribution characteristic of transmittance of the subpixels, the wavelength distribution characteristics being represented as variables of the quantity of light from the backlight module in a table format.

11. A liquid crystal display, comprising:
a liquid crystal panel comprising a pair of substrates, a liquid crystal layer interposed between the substrates, and a plurality of electrodes for applying an electric field to the liquid crystal layer, the panel including a plurality of subpixels formed therein;
a backlight module capable of controlling light emission for each color;
correcting means for correcting mismatching between a wavelength distribution characteristic of light emission from the backlight module and a wavelength distribution characteristic of transmittance of the subpixels; and
a controller for adjusting the transmittance of the subpixels and the quantity of light emitted from the backlight module, on the basis of correction information created by the correcting means.

12. A liquid crystal display according to claim 11, wherein:
the plural subpixels include subpixels of three colors corresponding to red, green, and blue; and
the backlight module includes light sources of three colors corresponding to red, green, and blue.

13. A liquid crystal display according to claim 11, further comprising driving means for driving the light sources of the respective colors in an independent fashion.

14. A liquid crystal display, comprising:
a liquid crystal panel comprising a pair of substrates, a liquid crystal layer interposed between the substrates, and a plurality of electrodes for applying an electric field to the liquid crystal layer, the panel including a plurality of subpixels formed therein;
a backlight module capable of controlling light emission for each color;
data receiving means for receiving information, stored in an external device, of a wavelength distribution characteristic of light emission from the backlight module and a wavelength distribution characteristic of transmittance of the subpixels;
means for obtaining, on the basis of the information received by the data receiving means, information of crosstalk caused by mismatching between the wavelength distribution characteristic of light emission from the backlight module and the wavelength distribution characteristic of transmittance of the subpixels; and
a controller for adjusting the transmittance of the subpixels and the quantity of light emitted from the backlight module, on the basis of the information of the crosstalk.

15. A liquid crystal display according to claim 14, wherein:
the plural subpixels include subpixels of three colors corresponding to red, green, and blue; and
the backlight module includes light sources of three colors corresponding to red, green, and blue.

16. A liquid crystal display according to claim 14, further comprising driving means for driving the light sources of the respective colors in an independent fashion.

17. A liquid crystal display according to claim 14, wherein the controller determines the transmittance of the subpixels on the basis of the quantity of light emitted from the backlight module and the information of crosstalk.
